(19) United States
(12) Patent Application Publication
(10) Pub. No.: US 2016/0182156 A1
(43) Pub. Date: Jun. 23, 2016

(54) Adjustable Receiver with Addressable Parameters

(71) Applicant: Broadcom Corporation, Irvine, CA (US)

(72) Inventors: Frederick Sugihwo Tang, Los Altos, CA (US); Vasudevan Parthasarathy, Irvine, CA (US); John Szeming Wang, Sunnyvale, CA (US); Rajiv Pancholy, San Clemente, CA (US)

(21) Appl. No.: 14/611,181

(22) Filed: Jan. 31, 2015

Related U.S. Application Data
(60) Provisional application No. 62/096,325, filed on Dec. 23, 2014.

(51) Int. Cl. H04B 10/61

(52) U.S. Cl. CPC H04B 10/616

(57) ABSTRACT

A system includes an adjustable receiver a data line, a communications bus, and signal processing circuitry. The adjustable receiver may receive a signal and pass the received signal to the signal processing circuitry for data recovery and processing. For example, the adjustable receiver may detect an optical signal and pass the detected signal to signal processing circuitry for analog-to-digital conversion and digital processing. The signal processing circuitry may apply criteria to received signal to determine adjustment of selected parameters for the adjustable receiver. The signal processing circuitry may access addressable parameters in the adjustable receiver via the communications bus. By addressing the parameters the signal processing circuitry may apply the determined adjustments to the selected parameters in the adjustable receiver.

### PRIORITY CLAIM

This application claims priority to provisional application Ser. No. 62/096,325, filed Dec. 23, 2014, which is entirely incorporated by reference.

### TECHNICAL FIELD

This disclosure relates configuration of signal reception circuitry. This disclosure also relates to signal reception circuitry in optical receivers.

### BACKGROUND

High speed networks form part of the backbone of what has become indispensable worldwide data connectivity. The networks include wireless, optical, and coaxial connections between devices. Optical networking provides for high throughput data channels and is used to form backbone connections in many high-speed data networks. As consumer demand for bandwidth increases, the installed base of optical networking components increasingly pushes the high-throughput optical network closer to the consumer premises. Improvements in optical component operation will ease deployment as the installed base increases.

### BRIEF DESCRIPTION OF THE DRAWINGS

FIG. 1 shows an example device.

FIG. 2 shows example adjustment logic.

FIG. 3 shows an example adjustable receiver.

FIG. 4 shows another example adjustable receiver.

### DETAILED DESCRIPTION

The discussion below concerns techniques and architectures for addressing configuration inputs in an adjustable receiver with configurable parameters. The techniques and architectures may allow for independent parameter addressing through a compact set of pins. Through these pins, virtually any number of parameters for the adjustable receiver may be controlled. In an example system, the adjustable receiver may include a trans-impedance amplifier (TIA) for an optical receiver, such as a receiver optical subassembly (ROSA). The addressable parameters may be automatically controlled. For example, digital signal processing (DSP) circuitry for processing received signals may control the adjustable receiver via feedback controls.

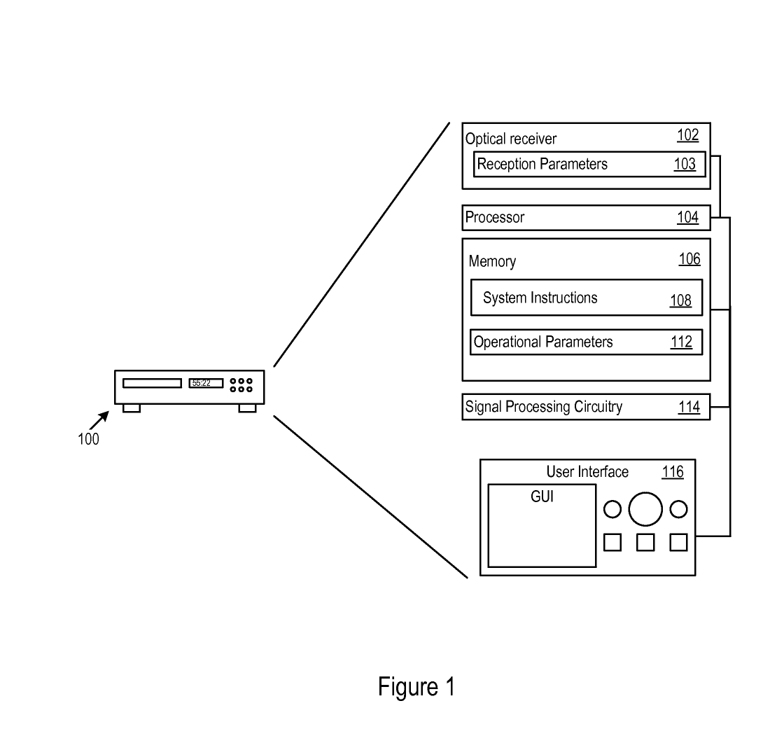

FIG. 1 shows an example device 100. In one example, the device may be a communication device, such as a cable headend, networking hub, switch, router, server, or other device. However, the device may be virtually any device implementing an adjustable receiver with configurable parameters. For example, the device may be any device performing digital or analog signal processing on received signals. Similarly, the configurable parameters may vary widely, and are not limited to the examples given below. Instead, the configured techniques may be used in connection with any set of configurable parameters regardless of type and regardless of device.

The device 100 may include optical receiver components 102 (e.g., photodiodes or other detection circuitry, ROSAs, coherent receivers, modulators, or other components) to support the reception of optical communication signals, one or more processors 104 to support execution of applications and control the general operation of the device. The device 100 may include memory 106 for execution support and storage of system instructions 108 and operational parameters 112. Signal processing circuitry 114 (e.g., Analog to Digital Converters (ADCs), baseband processors, digital-to-analog converters (DACs), and/or other signal processing circuits) may also be included to support reception of signals. The signal processing circuitry 114 may include amplifiers to adjust input signal levels to selected output levels. The signal processing circuitry 114 may also include an application specific component (e.g. a demodulator, or other application specific component) to process received signals.

In some cases, the adjustable receiver may allow for addressable adjustment one or more parameters. The parameters may be stored in any of the system circuitry, including the memory 106. The signal processing circuitry 114 may send signals to adjust the addressable parameters in the adjustable receiver. The optical receiver may include reception parameters 103 for control detector values, sensor settings and/or other parameters for reception. The reception parameters may be stored in addressable memory registers. The signal processing circuitry 114 may send commands to control operations of the optical receiver. The commands may be addressed to the individual parameters controlling reception in the optical receiver. For example, the signal processing circuitry 114 may implement a feedback control loop to maintain one or more signal level or signal quality thresholds and/or other signal characteristics by adjusting the adjustable amplifier in real-time or near real-time. The device 100 may also include a user interface 116 to allow for user operation of the device 100.

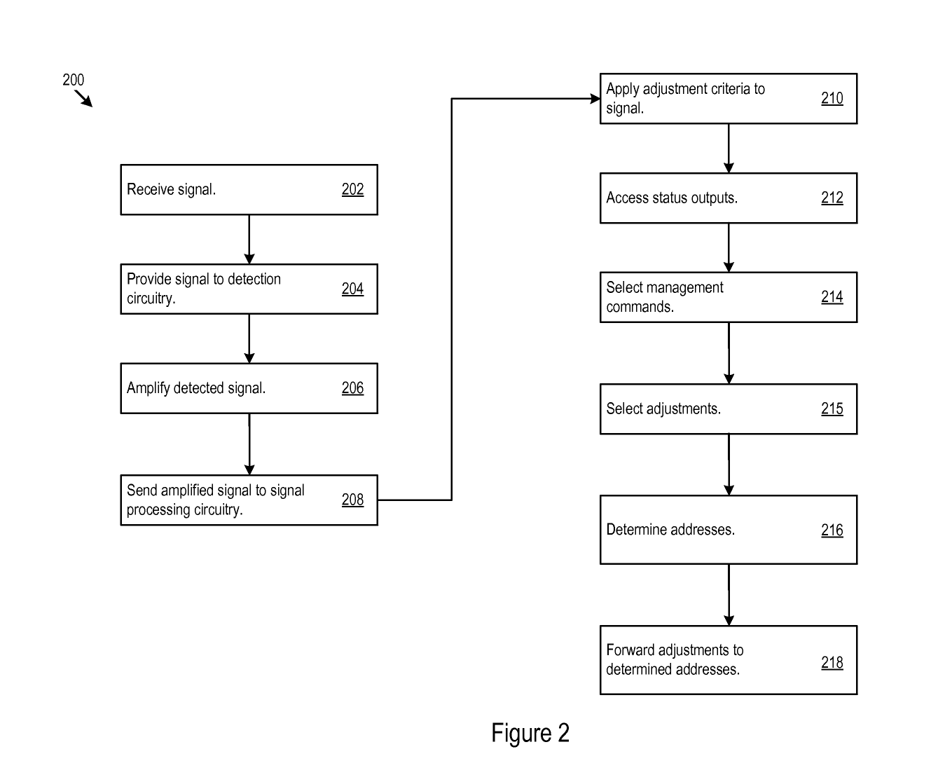

FIG. 2 shows example adjustment logic 200 which may be implemented in hardware, software, or both in the device 100. A signal may be received (202). For example, the signal may be a signal modulated on an optical carrier. The signal may include multiple polarization components, which may be independently modulated. The signal may include in-phase (I) and quadrature (Q) components. The signal may be split into one or more component parts. The signal may be provided to detection circuitry (204), which determines a detected signal given the received optical input. The detected signal may be amplified (206). The receiver may amplify the signal according to a current set of parameters for amplification. The parameters may include default parameters, initial parameters, the last set of parameters selected by the adjustment logic 200, stored parameters and/or other parameters. Once amplified, the signal may be sent to signal processing circuitry (208).

The signal processing circuitry may apply adjustment criteria to the signal (210). For example, the adjustment criteria may include signal level or quality thresholds. In an example scenario, signal amplitude of the signal may be lower than a selected threshold (e.g., a pre-stored or pre-determined threshold) specified by an adjustable or non-adjustable parameter. In response, the adjustment logic 200 may select a gain parameter of the amplifier to be increased. In another scenario, a signal-to-noise ratio (SNR) of the signal may be below a selected threshold and the amplitude of the signal may be above a selected threshold. In response, a gain parameter of the amplifier may be reduced to lower the amplitude and increase the SNR. In another example scenario, multiple parameters may be adjusted to increase a measured metric at the signal processing circuitry (e.g., gain, impedance, photodiode bias voltages, and/or other parameters). The adjustment logic 200 may also access status outputs from the adjustable receiver (212), such as peak indicators or other status outputs.

Further, the adjustment logic 200 may select management commands for the adjustable receiver (214). For example, the adjustment logic may issue a shutdown or startup command to the adjustable receiver. The adjustment logic 200 may select adjustments for the adjustable receiver based on the criteria (215). Once the parameter adjustments, status output, or management commands are selected, the adjustment logic 200 may determine the address for the parameter to be adjusted and/or read (216). For example, a given command or adjustment may be executed by changing or reading one or more values within an addressable memory register. The adjustment logic 200 may determine which addresses are associated with the parameters that will be changed or read to execute the commands or adjustments. The adjustment logic 200 may forward the commands or adjustments to the determined addresses (218).

In various implementations, addressing circuitry including addressable memory registers may implement the addressing system in the adjustable receiver. In some cases, the addressing system may operate at a lower frequency than that of the data channels of the receiver. For instance, the adjustable receiver may receive signals of up to 40 Gbps or more. However, the addressing circuitry implementing the addressing system of the adjustable receiver may accept addressing signals on a carrier signal. For example, a carrier signal at 400 KHz or 25 MHz may be used. However, carrier signals at other frequencies may be used. The bit-rate (and associated carrier) of the receiver and carrier frequency of the addressing signals may vary greatly. For example, the receiver carrier may be an optical or near infrared carrier, while the addressing carrier to the addressing circuitry may be a relatively low-speed radio frequency (RF) carrier. However, in a given system the addressing carrier need not necessarily be capable of supporting bit-rates of that of the data channel of the adjustable receiver system. Rather, the addressing carrier may be selected such that widely available RF electronics may be used.

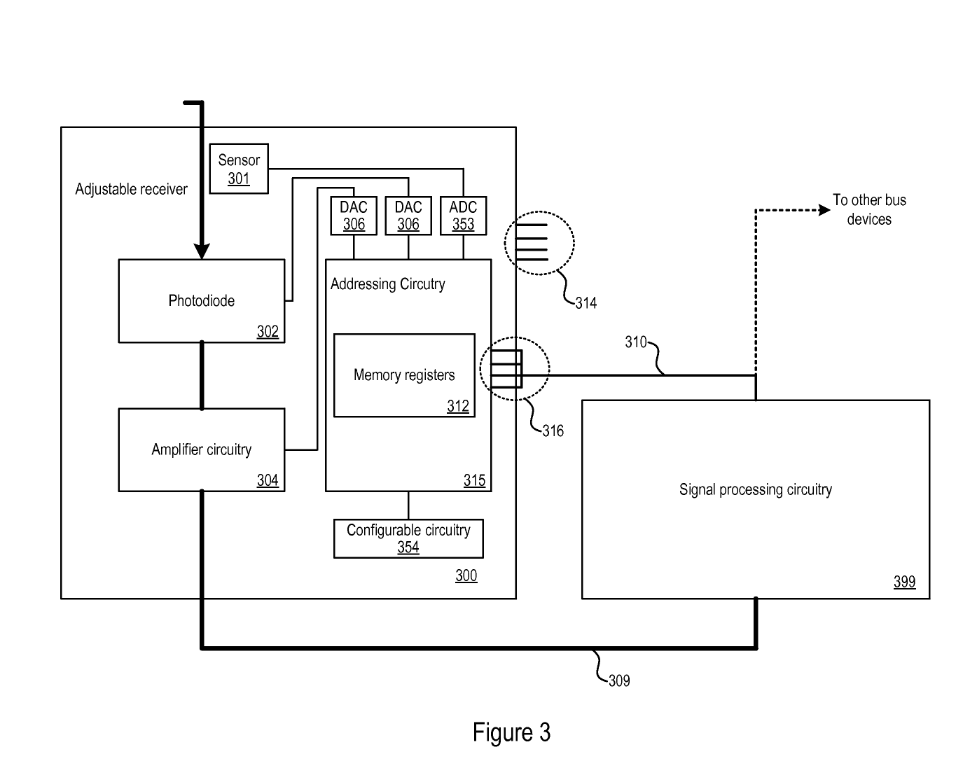

FIG. 3 shows an example adjustable receiver 300. The example adjustable receiver 300 is an optical receiver. However, other receiver types may be used, such as high-speed RF receivers and/or other receivers. The example adjustable receiver 300 includes a photodiode 302. For example, the adjustable receiver may include photodiodes with response ranges in various communications bands (e.g., wavelengths of 810 nm-1600 nm) or in the broader optical (350 nm-750 nm) or near/mid infrared (750 nm-2000 nm). The photodiode 302 may be coupled to amplifier circuitry 304. For example, the amplifier circuitry 304 may include a TIA. The datastream signal output of the photodiode 302 and amplifier circuitry 304 may be coupled to signal processing circuitry 399 via data line 309. For example, the signal processing circuitry 399 may include DSP circuitry. The parameters of the adjustable receiver parameters for the photodiode 302 and amplifier circuitry 304 may be controlled by addressing circuitry 315. The addressing circuitry 315 may be coupled to the signal processing circuitry 399 via a communications bus 310. In some cases, the communications bus 310 may be coupled through one or more pins, pins, pads, solder bumps, or other coupling interface, on the outside of the adjustable receiver chassis. In the specific example shown in FIG. 3, the communications bus 310 is used by the signal processing circuitry to access memory registers 312 in a addressing circuitry 315 to adjust one or more parameters, such as, amplifier gain parameters, output amplitude levels, input attenuation, and/or other parameters, of the adjustable receiver 300. The various stored values in the memory registers may be read or written to read status outputs of sensors or change power levels supplied to components of the receiver. The parameter adjustments may be implemented via DACs 306 with output values that may be adjusted via register write operations. The status output readings, such as readings from sensors 301, may be implemented via ADCs whose outputs may be accessible via read operations to the register. In addition, virtually any configurable circuitry 354, which may be adjusted via communications bus 310 messages, may be controlled via the addressing circuitry 315.

The addressing circuitry 315 may be used to control multi-value parameters such as amplifier gain levels. Additionally or alternatively, the addressing circuitry may be used to control binary values such as device power-on states, and/or activation states. For example, a device may include a binary state for a monitor photodiode activation or deactivation. DACs and register writes may be used to control either multi-value or binary parameters. In some cases, binary controls may be implemented though the addressing circuitry 315 directly via switching instead of DAC-based implementations.

In some cases, a parameter (e.g., binary or multi-value) may control a block such as a programmable sine wave generator instead of a DAC that is accessible by memory register. The sine wave generator may indicate the parameter value through generation of a particular sine wave values associated with particular parameter values. For example, the amplitude and frequency of the sine wave may be controlled by these parameter values. In some cases, the sine wave generator may implement a DAC to accomplish sine wave generation. However, the use of a DAC is not necessarily required.

The signal processing circuitry 399 may control other devices via the communications bus 310, and other devices may access the addressing circuitry 315 via the communications bus. For example, a remote monitoring terminal may access sensor 301 values via the communications bus 310 to allow for remote management of the adjustable receiver. The communications bus 310 may connect to a modem or network interface device for wide area network or local area network connectivity to facilitate remote or centralized management. For example, signal processing circuitry located on a central server may control multiple optical receiver devices, which may be spread over various physical locations or concentrated within a system housing. Additionally or alternatively, multiple control units, such as signal processing circuitry, remote terminals, and/or other control units, may control the adjustable receiver concurrently. For example, signal processing circuitry may control the adjustable receiver via an automated loop, while an operator may manually adjust parameters through a human interface.

In some implementations, external pins 314 may be reserved for power supply inputs and reference grounds. However, the usage these inputs may still be controlled within the addressing circuitry 315. In other cases, these inputs may be controlled outside the addressing circuitry 315. In various cases, power supply inputs may be implemented through addressing circuitry 315 and may not necessarily use reserved external pins. For example, the addressing circuitry may receive power though the communication bus pins and provide power signals through DACs 306. The addressing circuitry 315 may be coupled to the communications bus 310 via pins 316. In various implementations, the communications bus 310 may include an inter-integrated circuit (I2C) bus, a management data input/output (MDIO), a serial peripheral interface bus (SPI), a proprietary bus design, and/or other bus type.

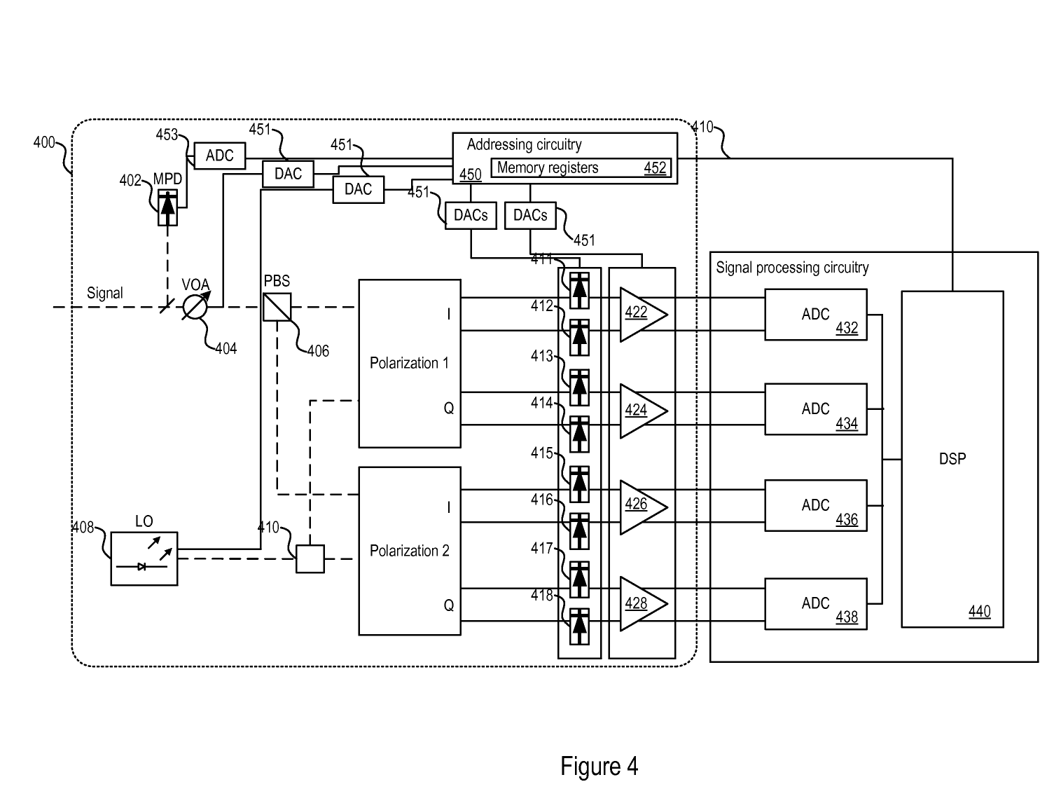

FIG. 4 shows another example adjustable receiver 400. In the adjustable receiver 400, the signal is received and sampled by the monitor photodiode (MPD) 402. A variable optical attenuator (VOA) 404 may attenuate the incoming signal. For example, the attenuation level may be based on the signal level detected at the MPD 402. The signal may be sent through a polarization beam splitter (PBS) 406 and separated in to two polarization components (e.g., X and Y linear polarization components, or other polarization components). A local oscillator (LO) 408 signal may be produced and split using an amplitude splitter or other component splitter. In some cases, a PBS may be used to split the LO signal. However, a non-polarizing splitter may be used. The polarization components may further be phase separated into I and Q components. The I and Q components may be detected by the photodiodes 411, 412, 413, 414, 415, 416, 417, 418. The output of the photodiodes 411, 412, 413, 414, 415, 416, 417, 418 may be amplified using the amplifiers 422, 424, 426, 428. The output of the amplifiers may be digitized using the ADCs 432, 434, 436, 438. The DSP circuitry 440 may process the digitized signal and reconstruct the received data stream. The DSP circuitry 440 may also control parameters of the amplifiers 422, 424, 426, 428; VOA 404; photodiodes 411, 412, 413, 414, 415, 416, 417, 418; MPD 402; and LO 408, via the communications bus 410 and addressing circuitry 450 via DACs 451 and ADCs 453. The DACs and ADCs may be accessible through the addressable memory registers 452 within the addressing circuitry 315. The Optical Internetworking Forum, in agreement OIF-DPC-RX-01.2, uses two form factors for optical receiver pin layouts.

Table 1 shows the pin usage of the type 1 form factor receiver.

TABLE 1
Type 1 form factor pin layout.

| Pin No. | Symbol | Description |
|---|---|---|
| 1 | SD-Y | Shutdown Polarization Y, I-component (YI) |
| | | (optional) |
| 2 | PI-YI | Peak indicator YI |
| 3 | GA-YI | Gain adjust YI |
| 4 | OA-YI | Output amplitude adjust YI |
| 5 | MPD+ | MPD Cathode (optional) |
| 6 | MPD− | MPD Anode (optional) |
| 7 | VCC-YI | Supply voltage amplifier YI |
| 8 | GND | Ground reference |
| 9 | PD-YI | Photodiode bias voltage YI |
| 10 | PD-YI | Photodiode bias voltage YI |
| 11 | PD-YQ | Photodiode bias voltage Y Q-component (Q) |
| 12 | PD-YQ | Photodiode bias voltage YQ |
| 13 | GND | Ground reference |
| 14 | VCC-YQ | Supply voltage amplifier YQ |
| 15 | MC/MGC-Y | Manual gain control (MGC)/Automatic gain |
| | | control (AGC) selection Y (optional) |
| 16 | RFU | Reserved for future use |
| 17 | OA-YQ | Output amplitude adjust YQ |
| 18 | GA-YQ | Gain adjust YQ |
| 19 | PI-YQ | Peak indicator YQ |
| 20 | RFU | Reserved for future use |
| 40 | RFU | Reserved for future use |
| 39 | PI-XQ | Peak indicator Polarization X, Q |
| 38 | GA-XQ | Gain adjust XQ |
| 37 | OA-XQ | Output amplitude adjust XQ |
| 36 | RFU | Reserved for future use |
| 35 | MC/MGC-X | MGC/AGC selection X (optional) |
| 34 | VCC-XQ | Supply voltage amplifier XQ |
| 33 | GND | Ground reference |
| 32 | PD-XQ | Photodiode bias voltage XQ |
| 31 | PD-XQ | Photodiode bias voltage XQ |
| 30 | PD-XI | Photodiode bias voltage XI |
| 29 | PD-XI | Photodiode bias voltage XI |
| 28 | GND | Ground reference |
| 27 | VCC-XI | Supply voltage amplifier XI |
| 26 | RFU | Reserved for future use |
| 25 | RFU | Reserved for future use |
| 24 | OA-XI | Output amplitude adjust XI |
| 23 | GA-XI | Gain adjust XI |
| 22 | PI-XI | Peak indicator XI |
| 21 | SD-X | Shutdown XI (optional) |

Table 2 shows the pin usage of the type 2 form factor receiver.

TABLE 2
Type 2 form factor pin layout.

| Pin No. | Symbol | Description |
|---|---|---|
| 1 | RFU | Reserved for future use |
| 2 | RFU | Reserved for future use |
| 3 | MC/MGC | MGC/AGC selection (optional) |
| 4 | MPD+ | MPD Cathode (optional) |
| 5 | MPD− | MPD Anode (optional) |
| 6 | PD-YI | Photodiode bias voltage YI |
| 7 | PD-YI | Photodiode bias voltage YI |
| 8 | PD-YQ | Photodiode bias voltage YQ |
| 9 | PD-YQ | Photodiode bias voltage YQ |
| 10 | PI-YI | Peak indicator YI |
| 11 | GA-YI | Gain adjust YI |
| 12 | OA-YI | Output amplitude adjust YI |
| 13 | VCC-Y | Supply voltage amplifier Y |
| 14 | GND | Ground reference |
| 15 | OA-YQ | Output amplitude adjust YQ |
| 16 | GA-YQ | Gain adjust YQ |
| 17 | PI-YQ | Peak indicator YQ |
| 34 | RFU | Reserved for future use |
| 33 | RFU | Reserved for future use |
| 32 | SD | Shutdown (optional) |
| 31 | VOA1 | Variable optical attenuator (VOA) |
| | | 1 adjust voltage (optional) |
| 30 | VOA2 | VOA2 adjust voltage (optional) |
| 29 | PD-XQ | Photodiode bias voltage XQ |
| 28 | PD-XQ | Photodiode bias voltage XQ |
| 27 | PD-XI | Photodiode bias voltage XI |
| 26 | PD-XI | Photodiode bias voltage XI |
| 25 | PI-XQ | Peak indicator XQ |
| 24 | GA-XQ | Gain adjust XQ |
| 23 | OA-XQ | Output amplitude adjust XQ |
| 22 | VCC-X | Supply voltage amplifier X |
| 21 | GND | Ground reference |
| 20 | OA-XI | Output amplitude adjust XI |
| 19 | GA-XI | Gain adjust XI |
| 18 | PI-XI | Peak indicator XI |

In various implementations, the TIA power supply, ground, and photodiode bias pins may be reserved and made available to board/circuit designers. However, other pins (e.g., shutdown, manual/automatic gain selection, output amplitude and gain adjust, peak indicator) may be made addressable through the addressing circuitry. The voltage for controlling the addressable parameters can be controlled using DACs whose values are settable via register writes of the memory register in the addressing circuitry. Addressable outputs, (e.g., a peak indicator, or other outputs) may be implemented using ADCs whose values are accessible through register reads of the memory registers of the addressing circuitry. Therefore, the function of multiple external pins used in the above form factors may be performed by the addressing circuitry the DACs and ADCs associated with the addressable values in the memory register.

The 40 pins of the type 1 form factor may be implemented via 18 pins while reserving ground and power supply pins (4 TIA power supply pins, 4 ground pins, 8 photodiode bias pins, and 2 communication pins). Alternatively, combined pins may be used for the power supplies, grounds, and/or photodiode biases. In the combined reserved pin layout, 3 pins in addition to the bus pins may be used. In some cases (e.g., 12C, MDIO) two bus pins may be used. Other bus types may use other numbers of pins, for example SPI buses may use 4 pins.

The 34 pins of the type 2 form factor may be implemented using 18 pins with separate power, ground, and bias pins. The type 2 form factor may be implemented using 5 pins when combined power, ground, and bias pin layouts are used.

The pin combinations discussed here are example layouts and other pin configurations may be used. For example, one or more values controlled by the addressing circuitry may also have associated reserved pins for control of the parameter on the device chassis. Thus, the values may be controlled via pin input or parameter addressing control. A setting within the memory register of the addressing circuitry may indicate whether an addressable value or the pin input will be used for a given parameter. In other cases, addressing circuitry control may be applied to selected parameters. For example, in a given system, control via the addressing circuitry may be applied to a parameter such as gain adjustment but not to a parameter such as output amplitude adjustment. Thus, the parameters that are controlled via addressing circuitry need not necessarily include all parameters that theoretically could be controlled via the addressing circuitry.

In some cases, feedback control via DSP may replace manual correction of the adjustable receiver parameters. For example, an automatic gain control (AGC) sweep executed by a user through a user interface may be automated through the feedback control. For example, a DSP algorithm may directly manipulate the addressable parameters via the communication buses to achieve selected targets for performance. Alternatively or additionally, peak searching algorithms may be used to find performance extrema (or local extrema) such as highest signal levels, lowest error rates, and/or extrema for other metrics. Selected settings can be stored and loaded after power up, reset, periodically, aperiodically, and/or at triggering events. Receiver characteristics may change with the age of the receiver. The DSP feedback controls may adjust the parameters of the adjustable receiver to mitigate effects of aging. Additionally or alternatively, continuously adaptive parameter adjustment with running traffic is possible using feedback control. Thus, the system may have tuned performance in real-time or near real-time.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

What is claimed is:

1. A device comprising:
a receiver configured to detect an optical input to produce a signal, the detection based on multiple optical reception parameters for the receiver; and
adjustment circuitry configured to:
responsive to the signal, receive, via a communications bus, an adjustment addressed to a first parameter of the multiple optical reception parameters; and
responsive to reception of the adjustment, cause the reception circuitry to adjust the first parameter.

2. The device of claim 1, wherein the receiver is configure to send the signal to signal processing circuitry for data stream recovery.

3. The device of claim 1, wherein the optical input comprises a first polarization component and a second polarization component.

4. The device of claim 3, wherein reception of the first polarization component is characterized by the first parameter.

5. The device of claim 1, wherein the first parameter comprises a gain level, an output amplitude adjustment, an attenuator voltage, a monitor photodiode voltage, a receiver power-on state, an activation state, or any combination thereof.

6. The device of claim 1, wherein:
the optical input comprises an in-phase component and a quadrature component; and
reception of the in-phase component, the quadrature component, or both is characterized by the first parameter.

7. The device of claim 1, wherein the communications bus is coupled to a chassis pin of the receiver.

8. The device of claim 7, wherein the first parameter and a second parameter of the multiple parameters may be addressed via the chassis pin.

9. The device of claim 1, wherein the adjustment circuitry comprises a memory register.

10. The device of claim 9, wherein the addressed adjustment is addressed to a first address of the memory register, the first address assigned to the first parameter.

11. The device of claim 9, wherein the multiple parameters are individually addressable through the memory register.

12. The device of claim 1, wherein the receiver is configured to send the signal to signal processing circuitry via a data line.

13. The device of claim 12, wherein the adjustment is sent by the signal processing circuitry responsive to application of a criterion to the signal.

14. The device of claim 13, wherein the criterion comprises a signal level threshold, a signal quality threshold, or both.

15. A method comprising:
detecting, at a receiver, an optical input to generate a signal;
sending the signal, via a data line, to signal processing circuitry;
applying, at the signal processing circuitry, a criterion to the signal;
responsive to the application of the criterion, determining to adjust a first parameter of the receiver;
sending, via a communications bus, a first adjustment, the first adjustment addressed to the first parameter; and
adjusting the first parameter at the receiver.

16. The method of claim 15, wherein the first parameter comprises a gain level, an output amplitude adjustment, an attenuator voltage, a monitor photodiode voltage, or any combination thereof.

17. The method of claim 15, wherein applying the criterion comprises applying a signal quality threshold, a signal level threshold, or both.

18. The method of claim 15, further comprising:
responsive to the criterion, determining to adjust a second parameter of the receiver;
sending, via the communications bus, a second adjustment, the second adjustment addressed to the second parameter; and
adjusting the second parameter at the receiver.

19. A system comprising:
a data line;
a communications bus;
a receiver coupled to the data line and the communications bus, the receiver configured to detect an optical input to produce a signal, the detection characterized by a parameter; and
signal processing circuitry coupled to the data line and the communications bus, the signal processing circuitry configured to:
receive the signal from the receiver via the data line;
apply a criterion to the signal;
responsive to the application of the criterion, determine an adjustment for the parameter; and
send the adjustment to the receiver via the communications bus, the adjustment individually addressed to the parameter.

20. The system of claim 19, wherein the signal processing circuitry is further configured to apply the criterion periodically to mitigate changes to signal level, signal quality, or both.
